(19) United States
(12) Patent Application Publication
(10) Pub. No.: US 2011/0027013 A1
(43) Pub. Date: Feb. 3, 2011

(54) BALL JOINT

(75) Inventors: Dirk Sokolihs, Bramsche (DE); Frank Grundmann, Westerkappeln (DE); Sonja Ahlert, Hagen (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/935,370

(22) PCT Filed: Apr. 2, 2009
(86) PCT No.: PCT/DE09/50014

§ 371 Date: Oct. 13, 2010

(30) Foreign Application Priority Data
Apr. 4, 2008 (DE) 10 2008 000 996.2

(51) Int. Cl. F16C 11/06

(52) U.S. Cl. 403/134

(57) ABSTRACT

A ball joint for a motor vehicle. The ball joint has a housing, a ball pin that is supported within the housing in a rotatable and pivotal manner, and a bellows seal. The bellows seal rests with a first bellows seal edge in a sealing manner against the ball pin, and with a second bellows seal edge rests in a sealing manner against the housing. The one-piece bellows seal comprises at least first and second sections, between its bellows seal edges, having different geometries, of which a first section forms a round bodied contour and a second section has an extension along the outer surface and in the direction of the longitudinal axis of the housing. The inner surface of the second section of the bellows seal and/or the outer surface of the housing corresponding thereto is provided with a surface geometry having alternating directions.

This application is a National Stage completion of PCT/DE2009/050014 filed Apr. 2, 2009, which claims priority from German patent application serial no. 10 2008 000 996.2 filed Apr. 4, 2008.

### FIELD OF THE INVENTION

The invention relates to a ball joint.

### BACKGROUND OF THE INVENTION

A ball joint for a motor vehicle having a housing and a ball pin which is rotatably and pivotably supported in the housing, and also having a bellows seal is known from DE 195 45 567 A1. According to the disclosure in this publication, the bellow seal rests with a first edge of the bellows seal in a sealing manner on the ball pin and with a second edge of the bellows seal in a sealing manner on the housing, wherein the bellows seal implemented overall as one-piece has at least two sections of different geometry between its bellows seal edges, of which a first section forms a round bodied contour and a second section has an extension along the outer surface and in the direction of the longitudinal axis of the housing.

With a ball joint formed in this manner, it is possible, in comparison to other designs, to attain a very wide angular deflection, relative to the housing, of the ball pin that is supported in the housing, without having to be concerned about damaging the bellows seal sealing the inner components of the joint during this motion. This comparatively enlarged angular deflection is attained due to the fact that the bellows seal with its second section extends along the outer surface and rests on the housing. If the ball pin is pivoted in the housing by means of the ball joint formed on it, the bellows seal designed according to the document is able to yield to this pivoting movement. The second section of the bellows seal, located on the side of the bellows seal in the pivot direction of the ball pin, is lifted from the housing because a shearing load is exerted on this second section, and the bellows seal has elastic properties. On the opposite side, the second section of the bellows seal is subjected to a tensile stress. However, it is able to compensate for this tensile stress due to the parts of the bellows seal resting against the housing. In the ball joint described in DE 195 45 567 A1 a lubricating grease is provided for lubricating the inner parts of the joint. The bellows seal serves here as a lubricant reservoir. However, experience has shown that due to the presence of the lubricating grease the bellows seal tends to remain adhered to the outer surface of the housing in the area of the second section resting against the housing. This circumstance can be observed increasingly with increasing age of the lubricating grease present in the ball joint. With this, the function that is intended to be attained by the second section and its contact with the housing, namely, the lifting and with it the load relief of the bellows seal to be moved, is however no longer fulfilled. Therefore, the bellows seal even with such an implementation of a ball joint tends to wear prematurely. Due to the increased angular deflection, in comparison to known ball joint implementations realized with the ball joint, the bellows seal is excessively stressed. If the bellows seal is then no longer able to lift off from the housing this leads to a tendency to break in the developing fold sections, which ultimately leads to permanent damage to the bellows seal.

### SUMMARY OF THE INVENTION

The object of the invention is to provide a ball joint for a motor vehicle, the bellows seal of which makes large angular deflections reliably possible over a long life cycle without being subject to increased wear.

A ball joint for a motor vehicle having a housing and a ball pin which is rotatably and pivotably supported in the housing, and also having a bellows seal that with a first edge of the bellows seal rests in a sealing manner against the ball pin and with a second edge of the bellows seal rests in a sealing manner against the housing, where the one-piece bellows seal has at least two sections of different geometry between its bellows seal edges, of which a first section forms a round bodied contour and a second section has an extension along the outer surface and in the direction of the longitudinal axis of the housing, has been improved according to the invention in that the inner surface of the second section of the bellows seal and/or the outer surface of the housing corresponding thereto has a surface geometry having alternating directions.

With the design of a ball joint according to the invention it is possible to significantly reduce the overall contact surface between the second section of the bellows seal and the surface of the housing. Due to the reduced contact surface, the second section of the bellows seal no longer tends to bind with the surface of the housing and to adhere thereto. This is also the case when lubricating grease is used in the ball joint, and in doing so the bellows seal is used as a lubricating grease reservoir. With a ball joint designed according to the invention, even tough lubricating grease materials that are inclined to resinify or that are subject to such a change due to thermal or other influences, can no longer cause adhesion between the bellows seal and the outer surface of the housing. Owing to the invention, it has thus become possible to improve the overall service life of a ball joint and to avoid premature wear of the bellows seal. A ball joint of this design is able to carry out large angular deflections of the ball pin relative to the housing without causing damage to the bellows seal. In tests, angular deflections of the ball pin of more than 50° relative to the housing were attained under constant loading of the ball joint, without damage to the bellows seal.

According to a first embodiment of the invention, the alternating direction can be a wave contour. This wave contour can be formed on both the inner surface of the second section of the bellows seal as well as on the outer surface of the housing corresponding thereto. A wave contour is advantageous for implementing the inventive idea because it permits an alternation of wave peaks and valleys without sharp edged transitions that lead to damage of the bellows seal. A sinusoidal shaped wave contour is preferable here. This is however not mandatory for implementing the invention.

Along with a wave-shaped contour it is also possible to provide cam-like elevations on the inner surface of the bellows seal in the area of the second section. These cam-like elevations can extend distributed over the entire inner surface of the second section of the bellows seal or can be arranged consolidated in groups. Point contact between the outer surface of the housing and the inner surface of the bellows seal is attained by the cam-like elevations. These point contacts, which are very small in cross-section, between the surfaces ease the lifting of the second section of the bellows seal during pivoting of the ball pin due to reduced friction between the surfaces.

Furthermore, it is also possible by implication however, to provide cam-like elevations on the outer surface of the housing corresponding to the second section of the bellows seal. Because the manufacturing expenditure for producing the cam-like elevations or a wave contour, influences also the cost expenditure for producing a ball joint according to the invention, it can be decided whether the cam-like elevations are provided on the inner surface of the second section of the bellows seal or on the outer surface of the housing.

A further variant of ball joint according to the invention consists in that the second section of the bellows seal at least in sections has linear-shaped elevations on its inner surface. As already described in the context of the cam-like elevations, the arrangement can occur individually or consolidated in groups. A linear-shaped contact between the surfaces also leads to the effect that the bellows seal does not remain adhered to the housing surface.

Analogous to this it is also possible that linear-shaped elevations are present at least in sections at the outer surface of the housing corresponding to the second section of the bellows seal.

Bellows seals for ball joints are as a rule provided with a round bodied contour. In order to keep the overall geometric dimensions of the bellows seal within limits, it is proposed that the second section of the bellows seal directly follows the first section of the bellows seal. With this, complex transitions between the sections of the bellows seal are avoided. The bellows seal can be implemented very compact and according to the requirements placed upon it. Furthermore, in this way materials savings are achieved, and the costs for producing the ball joint can be lowered.

In order to attain the largest possible angular deflections of the ball pin relative to the housing, a further development of the invention consists in that the second section of the bellows seal extends along a substantial part of the outer surface of the housing, observed in the direction of the longitudinal axis of the housing. Due to this relatively long extension of the second part of the bellows seal on the outer surface of the housing, sufficient material is available in order to implement the initially mentioned large angular deflections without damage occurring to the bellows seal.

In a concrete embodiment of this further development of the invention, the second section of the bellows seal extends along the outer surface of the housing, over at least ⅔ of the housing, viewed in the direction of the longitudinal axis of the housing. With such an embodiment it is possible to implement the previously mentioned angular deflections.

### BRIEF DESCRIPTION OF THE DRAWINGS

The invention is described in the following in more detail based on the drawings. The example embodiment shown does not limit the invention to only the variant shown, but rather serves merely for explaining the principle of the invention. In order to be able to illustrate the function according to the invention, only a very simplified schematic representation is shown in the figures, in which components that are not essential to the invention were omitted. This does not mean, however, that such components would not be present in a solution according to the invention.

They show:

FIG. 1: a perspective view of a ball joint in a sectional view, and

FIG. 2: an enlarged illustration of a detail of the second section of the bellows seal.

### DETAILED DESCRIPTION OF THE PREFERRED EMBODIMENTS

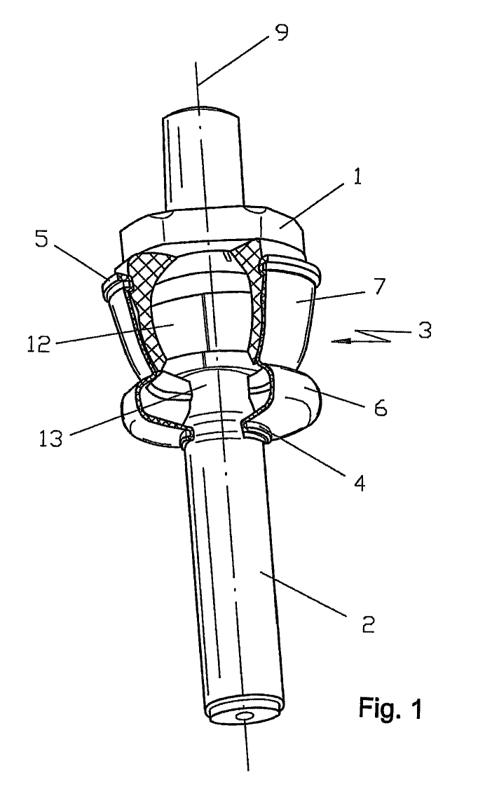

The ball joint shown in FIG. 1 has a housing 1. A ball pin 2 is rotatably and pivotably supported in the housing 1. For improved bearing properties the ball joint according to the illustration has a bearing shell 12 that with its inner surface area receives the joint ball of the ball pin 2 and with its outer surface is inserted directly in the housing 1 of the ball joint. In addition, the ball joint has a bellows seal 3 that with a first bellows seal edge 4 rests in a sealing manner directly on the pin-shaped section of the ball pin 2. On the side opposite of this first bellows seal edge 4, the bellows seal 3 has a second bellows seal edge 5 that is inserted into a corresponding groove-shaped recess in the housing 1 forming a seal, and is fixed to the housing 1 by a clamping ring, not shown in more detail. The first bellows seal edge 4 is also fastened by means of a clamping ring to the ball pin 2. The overall one-piece bellows seal 3 has two sections 6 and 7 that differ in their geometry. In the lower area associated with the pin-shaped part of the ball pin 2, the bellows seal 3 has the first section 6, having a round bodied contour. Directly adjacent thereto, the first section 6 of the bellows seal 3 transitions into a second section 7 which extends resting along the outer surface of the housing 1. From the representation of FIG. 1 it can further be seen that the axial extension of the second section 7 of the bellows seal 3 occurs over a substantial part of the housing 1. When speaking here of the axial extension this always means the direction of the components in the direction of the longitudinal axis 9 of the housing 1. In the representation in FIG. 1, this longitudinal axis 9 coincides with the longitudinal central axis of the undeflected ball pin 2. In the transition area between the pin-shaped section and the joint ball of the ball pin 2, there is a ball pin shaft 13 that is marginally reduced in cross-section relative to the pin shaped section of the ball pin 2, and here has a slightly conical progression.

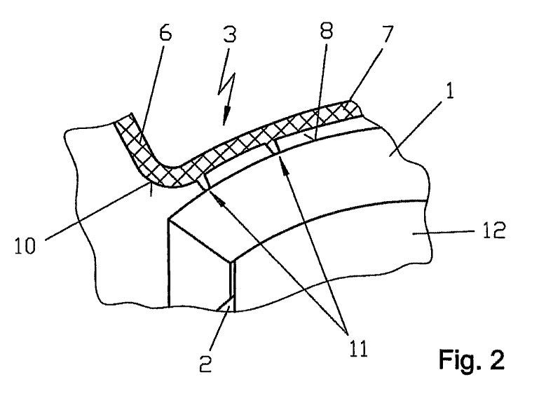

In FIG. 2 the inventive feature is more clearly apparent from the enlarged detailed view. This detailed view shows a detail of the area of the second section 7 of the bellows seal 3 in the transition from the first section 6 of the bellows seal 3. Here, the bellows seal 3 has an inner surface 10 that is provided with a plurality of cam-shaped elevations 11. These cam-shaped elevations 11 at their highest elevation directly contact the outer surface 8 of the housing 1. Due to these contact pairings the cam-shaped elevations 11 each have a point contact with the outer surface 8 of the housing 1, such that only a very small surface is in direct contact. With this, adhesion of the second section 7 of the bellows seal 3 is avoided, even when lubricating grease is used in the bellows seal 3 for lubricating the inner joint parts. The large angular deflection of the ball pin 2 within the housing 1 that is attainable in this manner is possible without having to be concerned that damage to the bellows seal 3 impacts the service life of the ball joint.

### LIST OF REFERENCE CHARACTERS

1 housing
2 ball pin
3 bellows seal
4 first bellows seal edge
5 second bellows seal edge
6 first section of the bellows seal
7 second section of the bellows seal
8 outer surface of the housing
9 longitudinal axis
10 inner surface of the bellows seal
11 elevations
12 bearing shell
13 ball pin

1-9. (canceled)

10. A ball joint for a motor vehicle comprising:
a housing (1),
a ball pin (2) being rotatably and pivotably supported in the housing (1), and
a one-piece bellows seal (3) having a first bellows seal edge (4) resting, in a sealing manner, against the ball pin (2) and a second bellows seal edge (5) resting, in a sealing manner, against the housing (1),
the one-piece bellows seal (3) having at least first and second sections (6, 7), between the first and the second bellows seal edges (4, 5), with different geometry of which the first section (6) forms a round bodied contour and the second section (7) has an extension along an outer surface (8) and in a direction of a longitudinal axis (9) of the housing (1),
at least one of an inner surface (10) of the second section (7) of the bellows seal (3) and the outer surface (8) of the housing (1), corresponding thereto, having a surface geometry with an alternating direction.

11. The ball joint according to claim 10, wherein the alternating direction forms a wave contour.

12. The ball joint according to claim 10, wherein the second section (7) of the bellows seal (3) has cam-like elevations (11) on the inner surface (10) thereof.

13. The ball joint according to claim 10, wherein cam-like elevations (11) are present on the outer surface (8) of the housing (1) corresponding to the second section (7) of the bellows seal (3).

14. The ball joint according to claim 10, wherein the second section (7) of the bellows seal (3) has, at least in sections, linear-shaped elevations (11) on the inner surface (10) thereof.

15. The ball joint according to claim 10, wherein linear-shaped elevations (11) are present, at least in sections, on the outer surface (8) of the housing (1) corresponding to the second section (7) of the bellows seal (3).

16. The ball joint according to claim 10, wherein the second section (7) of the bellows seal (3) is directly adjacent to the first section (6) of the bellows seal (3).

17. The ball joint according to claim 10, wherein the second section (7) of the bellows seal (3) extends along a substantial part of the outer surface (8) of the housing (1), when viewed along the longitudinal axis (9) of the housing (1).

18. The ball joint according to claim 10, wherein the second section (7) of the bellows seal (3) extends over two thirds of the housing (1), along the outer surface (8) of the housing (1), when viewed along the longitudinal axis (9) of the housing (1).

19. A ball joint for a motor vehicle, the ball joint comprising:
a housing (1) extending along a longitudinal axis (9);
a ball pin (2) being rotatably and pivotably received within the housing (1);
a bellows seal (3) having a first edge (4) contacting the ball pin (2) and forming a seal therewith and a second edge (5) contacting the housing (1) and forming a seal therewith, the bellows seal (3) being one-piece and having at least first and second sections (6, 7) of different geometry along the longitudinal axis (9) between the first edge (4) and the second edge (5), the first section (6) having a round bodied contour and the second section (7) encompassing an outer surface (8) of the housing (1) over a distance along the longitudinal axis to the seal formed between the housing (1) and the second edge (5) of the bellows seal (3); and
an end of an inner surface (10) of the second section (7) of the bellows seal (3), adjacent the first section (6) and spaced from the second edge (5) of the bellows seal (3), comprising a ridged surface profile with ridges on the inner surface (10) contacting an end of the outer surface (8) of the housing (1) being longitudinally spaced from the seal formed between the housing (1) and the second edge (5) of the bellows seal (3).
